(19) United States
(12) Patent Application Publication
(10) Pub. No.: US 2009/0231772 A1
(43) Pub. Date: Sep. 17, 2009

(54) CAR CHARGER AND SURGE PROTECTION DEVICE THEREOF

(75) Inventor: Ta Sung Hsiung, Hsinchu (TW)

Correspondence Address: APEX JURIS, PLLC, 12733 LAKE CITY WAY NORTHEAST, SEATTLE, WA, 98125, US

(73) Assignee: MITAC TECHONOLOGY CORP., Hsinchu (TW)

(21) Appl. No.: 12/206,991

(22) Filed: Sep. 9, 2008

(30) Foreign Application Priority Data
Mar. 11, 2008 (TW) 97108586

(51) Int. Cl. H02H 9/02; H02J 7/00

(52) U.S. Cl. 361/93.9; 320/114

(57) ABSTRACT

A surge protection device is coupled between a car power source and an output voltage end of a car charger. The surge protection device includes a diode, a current-limiting resistor, and a first transient voltage suppressor (TVS). The diode has an anode coupled to the car power source and a cathode coupled to the car charger. The current-limiting resistor has one end coupled to the anode of the diode. The first TVS is connected to the current-limiting resistor in series, and is connected in parallel with the current-limiting resistor between the car power source and the car charger. A reverse breakdown voltage of the first TVS should be smaller than a reverse breakdown voltage of the diode.

### CROSS-REFERENCES TO RELATED APPLICATIONS

This non-provisional application claims priority under 35 U.S.C. § 119(a) of Patent Application No(s). 97108586 filed in Taiwan, R.O.C. on 2008 Mar. 11, the entire contents of which are hereby incorporated by reference.

### BACKGROUND OF THE INVENTION

1. Field of Invention

The present invention relates to a charger and a surge protection device thereof, and more particularly to a car charger and a surge protection device thereof.

2. Related Art

A car charger provides power sockets in a car, so as to supply power to or charge mobile phones, GPS devices, or other portable electronic devices. Therefore, the car charger must comply with relevant safety specifications on cars. For example, the car charger must be capable of withstanding a certain degree of surge voltage, such that the surge voltage will not influence the normal operation of back end circuits.

FIG. 1 is a schematic view of a surge protection device in a car charger in the conventional art. Referring to FIG. 1, the surge protection device of the conventional art includes a diode A10 and a transient voltage suppressor (TVS) A20.

According to the conventional art, the TVS A20 is used to suppress the forward surge. In another aspect, a reverse voltage of the diode A10 is used to solve the reverse surge. That is to say, to prevent the reverse surge from flowing back, the withstand voltage of the diode A10 must be greater than the voltage of the reverse surge, so as to avoid the damage caused by the voltage of the reverse surge. However, though the problem caused by the reverse surge is solved, another negative problem appears; that is, when the reverse surge is greater, the withstand voltage of the diode A10 must be higher, and accordingly, a forward voltage (Vf) of the diode A10 must be higher as well.

The power loss of the diode A10 will increase with the increase of the forward voltage of the diode A10, resulting in a temperature rise. The temperature rise caused by the diode A10 is generated within the limited space of the car charger, so a heat sink must be added to solve this problem. Thus, the size of the car charger must be designed larger, and the additional heat sink increases the cost, which lowers the efficiency of the car charger.

For example, as specified in the JASO D001 B2 automotive standards, when the reverse surge is 260 V, to effectively block the voltage of the reverse surge, the reverse voltage of the diode A10 must be 300 V, and the forward voltage must be 1.5 V. Assume that the current flowing through the diode A10 is 1 A, the power loss on the diode A10 is 1.5 w, and at this time, a heat sink must be used to solve the problem of temperature rise.

Therefore, the problem caused by the surge protection device of the car charger in the conventional art is an important problem for researchers to solve.

### SUMMARY OF THE INVENTION

Accordingly, the present invention is directed to a car charger and a surge protection device thereof. The surge protection device of the present invention can use a diode having a low reverse voltage, so as to reduce a forward voltage of the diode. Thus, the diode will generate a low power loss, and will not cause the problem of temperature rise. Therefore, it is unnecessary to add a heat sink in a limited space of the car charger, thus saving the cost for the heat sink.

The present invention provides a surge protection device. The surge protection device is coupled between a car power source and a car charger, and includes a diode, a current-limiting resistor, and a first transient voltage suppressor (TVS). The diode has an anode coupled to the car power source and a cathode coupled to the car charger. The current-limiting resistor has one end coupled to the anode of the diode. The first TVS is connected to the current-limiting resistor in series, and is connected in parallel with the current-limiting resistor between the car power source and the car charger. A reverse breakdown voltage of the first TVS is smaller than a reverse breakdown voltage of the diode.

The present invention also provides another surge protection device. The surge protection device is coupled between a car power source and a car charger, and includes a diode, a current-limiting resistor, a first TVS, and a second TVS. The diode has an anode coupled to the car power source and a cathode coupled to the car charger. The current-limiting resistor has one end coupled to the anode of the diode. The first TVS is connected to the current-limiting resistor in series, and is connected in parallel with the current-limiting resistor between the car power source and the car charger. A reverse breakdown voltage of the first TVS is smaller than a reverse breakdown voltage of the diode. The second TVS has one end coupled to the cathode of the diode, and the second TVS is connected between the car power source and the car charger in parallel.

The present invention also provides a car charger. The car charger receives an input voltage from a car power source, and outputs an output voltage. The car charger includes a charging connector, a diode, a current-limiting diode, and a first TVS. The charging connector is provided to connect and charge external devices. The diode includes an anode receiving the input voltage and a cathode coupled to the charging connector. The current-limiting resistor has one end coupled to the anode of the diode. The first TVS is connected to the current-limiting resistor in series, and connected in parallel with the current-limiting resistor between the car power source and the charging connector. A reverse breakdown voltage of the first TVS is smaller than a reverse breakdown voltage of the diode.

Preferred embodiments of the present invention and their effects are described in the following with reference to the accompanying drawings.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view of a surge protection device of a car charger in the conventional art;

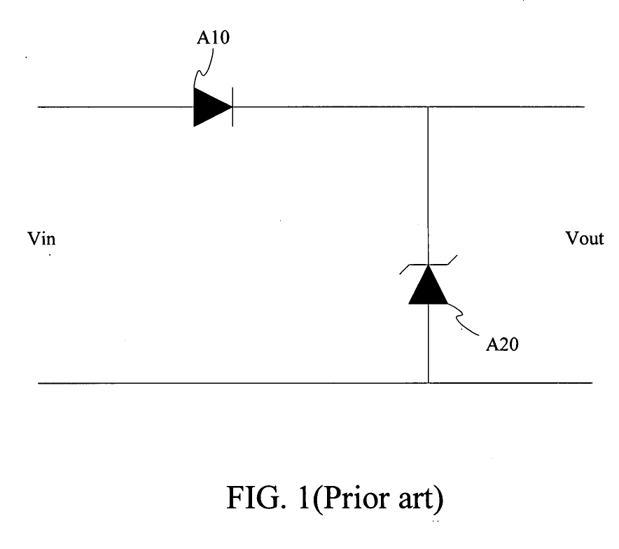

FIG. 2 is a schematic view of a surge protection device of a car charger according to a first embodiment of the present invention;

FIG. 3 is a schematic view of a surge protection device of a car charger according to a second embodiment of the present invention; and

FIG. 4 is a schematic view of a car charger according to an embodiment of the present invention.

### DETAILED DESCRIPTION OF THE INVENTION

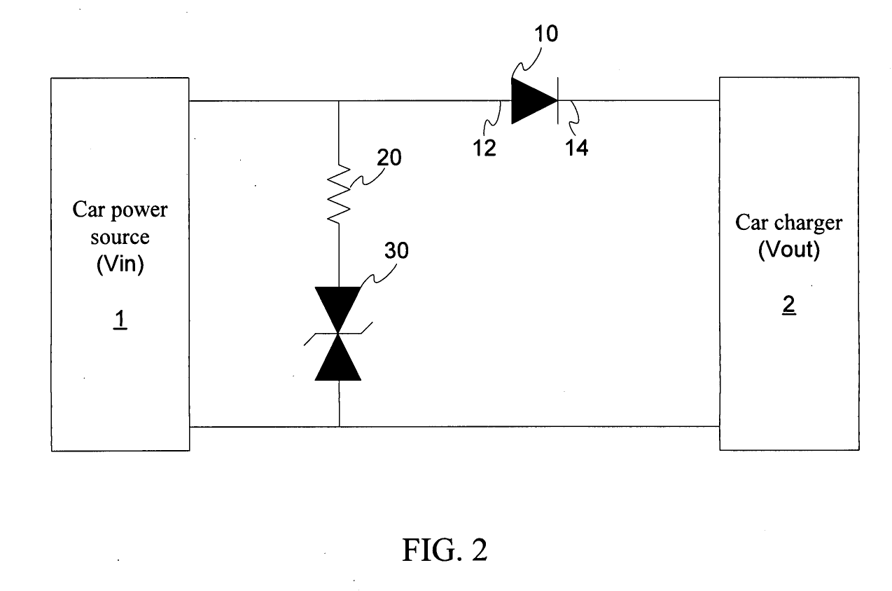

FIG. 2 is a schematic view of a surge protection device of a car charger according to a first embodiment of the present invention. Referring to FIG. 2, the surge protection device of a car charger of the present invention is coupled between a car power source and the car charger. The surge protection device according to the first embodiment includes a diode 10, a current-limiting resistor 20, and a first transient voltage suppressor (TVS) 30.

The diode 10 includes an anode 12 and a cathode 14. The anode 12 is coupled to the car power source 1, and the cathode is coupled to the car charger 2. The car charger 2 includes a DC-DC converter (not shown).

The diode is an electronic element having two electrodes, that is, two terminals including an anode and a cathode. In most cases, the diode is used for current rectification. The current rectification refers to that the electric current can flow in one direction. That is to say, the current is made to flow from the anode to the cathode (the forward bias), but cannot flow from the cathode to the anode (the reverse bias). The unidirectional electric current property is called current rectification. To put it simply, the diode allows the current to flow in one direction, but blocks the current in the reverse direction. Therefore, in the present invention, the diode 10 is coupled between the car power source 1 and the car charger 2, such that the forward current from the car power source 1 is transmitted to the car charger 2 after passing through the diode 10, and is used by an external electronic product to be charged or needing power. On the contrary, when a reverse surge appears on the car power source 1, the diode 10 blocks the reverse surge generated by the car power source 1 from flowing back, so as to prevent the damage to the internal elements of the car.

To effectively reduce the reverse withstand voltage (also referred to as the maximum working peak reverse voltage (VRWM) or reverse breakdown voltage) and lower the power loss, the present invention further includes the current-limiting resistor 20 and the TVS 30.

The current-limiting resistor 20 has one end coupled to the anode 12 of the diode 10. The first TVS 30 is connected to the current-limiting resistor 20 in series, and then the serially connected first TVS 30 and current-limiting resistor 20 are connected in parallel between the car power source 1 and the car charger 2. Here, the TVS is briefly introduced at first. The TVS is an effective protection element, which has characteristics similar to those of a Zener diode. Compared with the conventional Zener diode, the TVS has a P/N junction of a larger area, which, as a structural improvement, enables the TVS to have a stronger capability of withstanding high voltage, and reduces the voltage cut-off rate. Therefore, the TVS has a better effect in protecting the safety of the circuit through surge suppression. One of the most important features of the TVS is fast response, that is, a transient pulse can be effective suppressed before it causes damage to the circuit or elements. Moreover, the TVS has a lower leakage current, so the performance in processing the surge impact to high-rate transmission loops of the TVS is better.

In the present invention, the reverse breakdown voltage of the first TVS 30 is smaller than that of the diode 10. Therefore, the diode 10 with a lower reverse withstand voltage can be used, which can still be protected and will not be broken down by the reverse surge. At this time, when the reverse surge appears on the car power source 1, as the reverse breakdown voltage of the first TVS 30 is smaller than that of the diode 10, the first TVS becomes conductive at first, and the reverse surge flows through the current-limiting resistor 20, where the current of the reverse surge is lowered by the current-limiting resistor 20. Then, the reverse surge returns to the car power source 1. After the reverse surge flows through the first TVS 30 and the current-limiting resistor 20, the current back into the car power source 1 is a safe current that will not damage the internal elements in the car.

Here, the reverse conduction voltage of the diode 10 only needs to be slightly greater than that of the first TVS 30. The forward voltage of the diode 10 is proportional to the reverse breakdown voltage of the diode 10, and the power loss of the diode 10 is also proportional to the forward voltage of the diode 10. That is, the present invention uses the first TVS 30 and the current-limiting resistor 20, so the diode 10 with a lower reverse breakdown voltage can be used. Further, as the reverse breakdown voltage of the diode 10 is lower, the forward voltage is also lower, such that the power loss is reduced as well. Thus, the temperature of the surge protection device is reduced naturally, and no additional heat sink is required to solve the problem of temperature rise, so the space and cost for the heat sink is saved, and the efficiency of the car charger is improved.

For example, as described in the Related Art, according to the JASO D001 B2 automotive standards, when the reverse surge is 260 V, if the surge protection device of the present invention is not used, the diode 10 must have a reverse voltage of 300 V and a forward voltage of 1.5 V. Assume that the current flowing through the diode 10 is 1 A, the power loss on the diode 10 is 1.5 w, and at this time, a heat sink must be used to solve the problem of temperature rise. However, in the surge protection device of the present invention, assume that the reverse breakdown voltage of the first TVS 30 (which can be, but is not limited to, model P6KE56CA) is 56 V. That is, when the voltage of the reverse surge exceeds 56 V, the first TVS 30 becomes conductive, such that the surge flows back to the power source through the current-limiting resistor 20. Therefore, the reverse surge flows through the first TVS 30 and the current-limiting resistor 20, and the current of the reverse surge is reduced, so as to realize the protection effect. In this embodiment, the diode 10 has the reverse breakdown voltage of 60 V and the forward voltage of 0.55 V. Assume that the current flowing through the diode 10 is also 1 A, the power loss on the diode 10 is 0.55 w, which is only one third of the power loss in the prior art. Therefore, the heat sink is not needed, and the cost is saved.

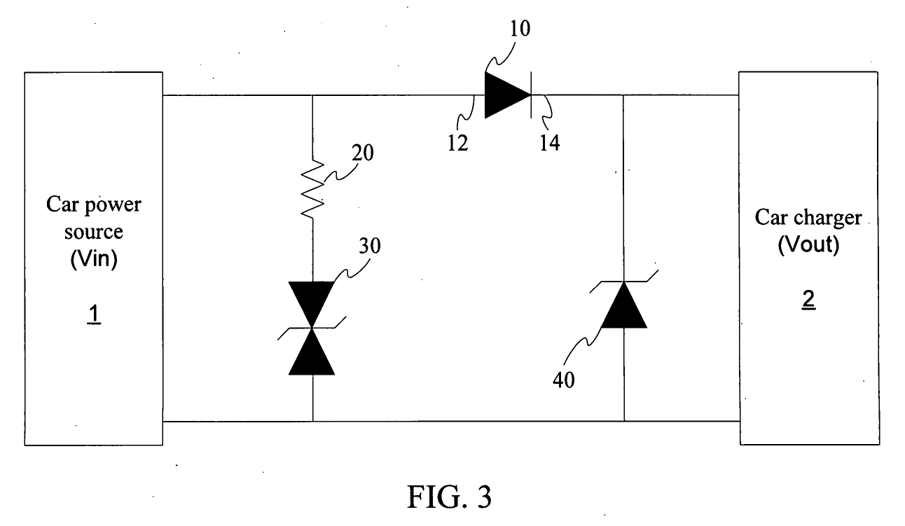

FIG. 3 is a schematic view of a surge protection device of a car charger according to a second embodiment of the present invention. The second embodiment further includes a second TVS 40.

The second TVS 40 has one end coupled to the cathode 14 of the diode 10, and the second TVS 40 is connected in parallel between the car power source 1 and the car charger 2. Here, the second TVS 40 can be used to suppress the forward surge generated by the car power source 1. The function of the second TVS 40 is similar to that of a Zener diode, so as to clamp the forward surge at a fixed value and output it to the car charger 2.

For example, assume that the second TVS 40 is set to 40 V. As specified in the JASO D001A1 automotive standards, when the high-voltage forward surge generated by the car power source 1 is 70 V, without the help of the second TVS 40, the forward surge of 70 V will flow to the car charger 2 directly, and then cause damage to the car charger 2 and the externally connected electronic products. The second TVS 40 can clamp the forward surge voltage of 70 V at 40 V, and then output it to the car charger 2. Thus, the forward surge is suppressed, so as to protect the car charger 2 and the externally connected electronic products.

It is known from FIG. 3 that the second TVS 40 can be unidirectional, and the first TVS 30 can be bidirectional. The unidirectional TVS 40 can suppress the forward surge, so as to prevent the forward surge from damaging the car charger 2 and the charged external electronic products. In another aspect, the bidirectional first TVS 30 not only can suppress the reverse surge as described earlier, but also can suppress the forward surge. That is, the first TVS 30 is designed to be bidirectional to suppress the reverse surge, and to help the second TVS 40 suppress the forward surge.

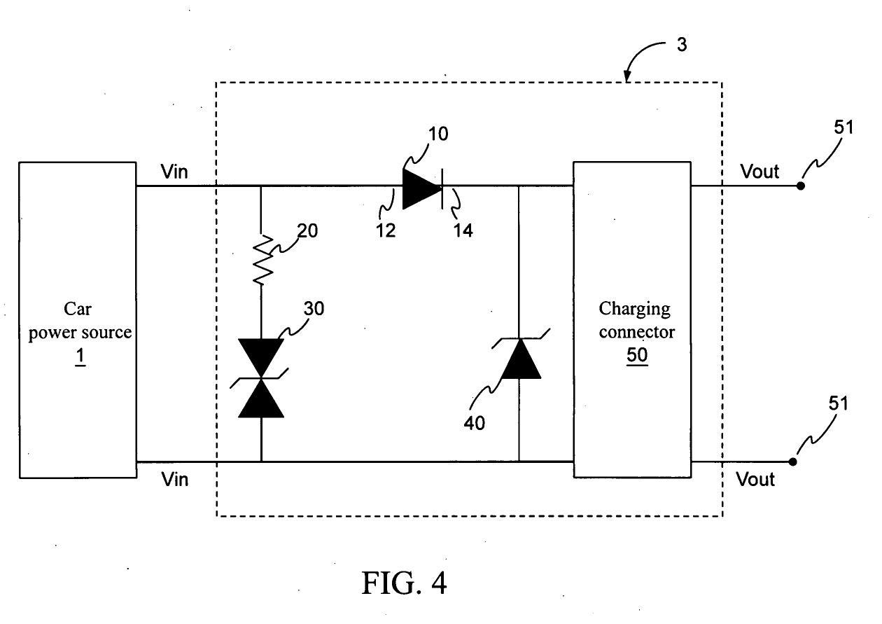

FIG. 4 is a schematic view of a car charger according to an embodiment of the present invention. In specific embodiments, the surge protection device can also be disposed in the physical space of the car charger to form a car charger having the surge protection function.

The car charger 3 has one end receiving an input voltage Vin provided by the car power source 1, and the other end being a charging connector 50 connecting an external device to charge the device. The external device can be a mobile phone, PDA, GPS device, and the like. An output end 51 of the charging connector 50 outputs an output voltage Vout.

This embodiment is similar to the previous embodiments technically. Therefore, the same technology is not repeated here, and only the connection of the elements of this embodiment is described briefly. The car charger 3 includes a charging connector 50 for connecting and charging the external device. The diode 10 includes an anode 12 receiving the input voltage and a cathode 14 coupled to the charging connector 50. The current-limiting resistor 20 has one end coupled to the anode 12 of the diode 10. A first TVS 30 is connected to the current-limiting resistor 20 in series, and is connected in parallel with the current-limiting resistor 20 between the car power source 1 and the charging connector 50. Here, the reverse breakdown voltage of the first TVS 30 is smaller than that of the diode 10. The second TVS 40 has one end coupled to the cathode 14 of the diode 10, and the second TVS 40 is connected in parallel between the car power source 1 and the charging connector 50.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A surge protection device of a car charger, coupled between a car power source and the car charger, comprising:
a diode, having an anode and a cathode, wherein the anode is coupled to the car power source, and the cathode is coupled to the car charger;
a current-limiting resistor, having one end coupled to the anode of the diode; and
a first transient voltage suppressor (TVS), connected to the current-limiting resistor in series, and connected in parallel with the current-limiting resistor between the car power source and the car charger, wherein a reverse breakdown voltage of the first TVS is smaller than a reverse breakdown voltage of the diode.

2. The surge protection device according to claim 1, wherein a reverse surge generated by the car power source flows through the first TVS and the current-limiting resistor, so as to reduce a current value of the reverse surge.

3. The surge protection device according to claim 1, wherein the reverse breakdown voltage of the diode is only slightly greater than the reverse breakdown voltage of the first TVS.

4. The surge protection device according to claim 3, wherein a forward voltage of the diode is proportional to the reverse breakdown voltage of the diode, and a power loss of the diode is proportional to the forward voltage of the diode.

5. The surge protection device according to claim 1, wherein the first TVS is bidirectional.

6. The surge protection device according to claim 1, further comprising:
a second TVS, having one end coupled to the cathode of the diode, and connected between the car power source and the car charger in parallel.

7. The surge protection device according to claim 6, wherein the second TVS suppresses a forward surge generated by the car power source at a fixed value.

8. The surge protection device according to claim 6, wherein the second TVS is unidirectional.

9. A surge protection device of a car charger, coupled between a car power source and the car charger, comprising:
a diode, having an anode and a cathode, wherein the anode is coupled to the car power source, and the cathode is coupled to the car charger;
a current-limiting resistor, having one end coupled to the anode of the diode;
a first transient voltage suppressor (TVS), connected to the current-limiting resistor in series, and connected in parallel with the current-limiting resistor between the car power source and the car charger, wherein a reverse breakdown voltage of the first TVS is smaller than a reverse breakdown voltage of the diode; and
a second TVS, having one end coupled to the cathode of the diode, and connected in parallel between the car power source and the car charger.

10. The surge protection device according to claim 9, wherein a reverse surge generated by the car power source flows through the first TVS and the current-limiting resistor, so as to reduce a current value of the reverse surge.

11. The surge protection device according to claim 9, wherein the second TVS clamps a forward surge generated by the car power source at a fixed value, and outputs the forward surge to the car charger.

12. The surge protection device according to claim 9, wherein the reverse breakdown voltage of the diode is only slightly greater than the reverse breakdown voltage of the first TVS.

13. The surge protection device according to claim 12, wherein a forward voltage of the diode is proportional to the reverse breakdown voltage of the diode, and a power loss of the diode is proportional to the forward voltage of the diode.

14. The surge protection device according to claim 9, wherein the first TVS is bidirectional.

15. The surge protection device according to claim 9, wherein the second TVS is unidirectional.

16. A car charger, receiving an input voltage from a car power source, and outputting an output voltage, the car charger comprising:
a charging connector, connecting and charging an external device;
a diode, having an anode and a cathode, wherein the anode receives the input voltage, and the cathode is coupled to the charging connector;
a current-limiting resistor, having one end coupled to the anode of the diode; and
a first transient voltage suppressor (TVS), connected to the current-limiting resistor in series, and connected in parallel with the current-limiting resistor between the car power source and the charging connector, wherein a reverse breakdown voltage of the first TVS is smaller than a reverse breakdown voltage of the diode.

17. The car charger according to claim 16, wherein a reverse surge generated by the car power source flows through the first TVS and the current-limiting resistor, so as to reduce a current value of the reverse surge.

18. The car charger according to claim 16, wherein the reverse breakdown voltage of the diode is only slightly greater than the reverse breakdown voltage of the first TVS.

19. The car charger according to claim 18, wherein a forward voltage of the diode is proportional to the reverse breakdown voltage of the diode, and a power loss of the diode is proportional to the forward voltage of the diode.

20. The car charger according to claim 16, wherein the first TVS is bidirectional.

21. The car charger according to claim 16, further comprising:
a second TVS, having one end coupled to the cathode of the diode, and connected in parallel between the car power source and the car charger.

22. The car charger according to claim 21, wherein the second TVS suppresses a forward surge generated by the car power source at a fixed value.

23. The car charger according to claim 21, wherein the second TVS is unidirectional.
